(19) United States
(12) Patent Application Publication
(10) Pub. No.: US 2025/0322765 A1
(43) Pub. Date: Oct. 16, 2025

(54) GENERATING MOTION CUES VIA LOW-LATENCY WIND GENERATION

(71) Applicant: Driven DynamiX LLC, Austin, TX (US)

(72) Inventor: Alexander Nankervis, Austin, TX (US)

(21) Appl. No.: 19/093,203

(22) Filed: Mar. 27, 2025

Related U.S. Application Data
(60) Provisional application No. 63/633,483, filed on Apr. 12, 2024.

(51) Int. Cl. G09B 9/16; G09B 9/30

(52) U.S. Cl. CPC G09B 9/16; G09B 9/30

(57) ABSTRACT

Embodiments for generating motion cues via low latency wind generation are described. A wind generation system is configured to dynamically generate wind in accordance with instructions for incidence in a target area. The wind is generated in response to movement of a simulated vehicle in a simulation. The target area is a region that is occupied by a user operating the simulated vehicle. A controller may determine a wind velocity vector based in part on telemetry data describing the movement of the simulated vehicle for a new time interval. The controller determines, based in part on the wind velocity vector, a wind velocity set point for at least one wind generator of the wind generation system. The controller determines the instructions based in part on the wind velocity set point, and provides the instructions for the new time interval to the wind generation system.

### CROSS REFERENCE TO RELATED APPLICATION

This application claims the benefit of U.S. Provisional Application No. 63/633,483, filed Apr. 12, 2024, which is incorporated by reference in its entirety.

### FIELD OF THE INVENTION

The disclosure relates generally to emulating sensory feelings of operating a real vehicle, and more specifically to generating motion cues via low-latency wind generation.

### BACKGROUND

In driver training and/or flight simulation systems, it is desirable to emulate a sensory feeling of being in a real vehicle, including its acceleration forces. In conventional simulation systems, motion simulators typically have limited ranges of travel, restricting them to simulating bumps, vibrations, and tilting. In such systems, acceleration forces may be approximated for only very short durations, after which the platform reaches the end of its travel limit and begins decelerating, thereby creating a sensation that is opposite of the desired effect.

### SUMMARY

In accordance with one or more aspects of the disclosure, generating motion cues via low latency wind is described. A wind generation system is configured to dynamically generate wind via one or more wind generators (e.g., fan assemblies) in accordance with wind control instructions for incidence in a target area. The wind generation system may be integrated into a vehicle simulator that is configured to provide a simulation that simulates, for a user, operation of a simulated vehicle. The wind is generated in response to movement (e.g., acceleration) of the simulated vehicle in the simulation, thereby, providing a motion cue to the user of the movement. The target area is a region that is occupied by the user.

A simulation controller determines the wind control instructions for one or more wind generators of the wind generation system. The simulation controller, for a new time interval, may determine a wind velocity vector based in part on telemetry data (e.g., a vehicle velocity vector, vehicle acceleration vector) describing movement of the simulated vehicle for the new time interval. The simulation controller may determine, based in part on the wind velocity vector, a wind velocity set point for at least one wind generator of the wind generation system. The controller determines the wind control instructions based in part on the wind velocity set point. The wind control instructions for the new time interval are provided to the at least one wind generator.

In some aspects, the techniques described herein relate to a vehicle simulator including: a structure including a cockpit configured to be occupied by a user for operation of a simulated vehicle of a simulation; an input device that is coupled to the structure and that is configured to receive inputs from the user to steer the simulated vehicle within the simulation; an output device configured to provide video content for the simulation; a wind generation system configured to dynamically generate wind using one or more wind generators that operate in a closed loop control configuration, in accordance with wind control instructions, in order to simulate changes in at least one of a magnitude of the wind and a direction of the wind for incidence in a target area in response to movement of the simulated vehicle, wherein the target area is occupied by the user; and a simulation controller that is configured to: generate, based in part on inputs received from the input device, the wind control instructions for at least one wind generator of the one or more wind generators, and provide the wind control instructions to the wind generation system.

In some aspects, the techniques described herein relate to a system including: a wind generation system configured to dynamically generate wind, in accordance with wind control instructions, in order to simulate changes in at least one of magnitude of the wind and direction of the wind for incidence in a target area in response to movement of a simulated vehicle in a simulation, wherein the target area is a region that is occupied by a user operating the simulated vehicle; and a simulation controller that is configured to: for each new time interval of the simulation, determine a wind velocity vector based in part on telemetry data that describes the movement of the simulated vehicle for the new time interval, determine, based in part on the wind velocity vector, a wind velocity set point for at least one wind generator of the wind generation system, determine the wind control instructions based in part on the wind velocity set point, and provide the wind control instructions for the new time interval to the wind generation system.

In some aspects, the techniques described herein relate to a non-transitory computer-readable storage medium including stored instructions, the instructions when executed by a processor of a device, cause the device to: for each new time interval of a simulation for operating a simulated vehicle, determine a wind velocity vector based in part on telemetry data that describes movement of the simulated vehicle for the new time interval, determine, based in part on the wind velocity vector, a wind velocity set point for at least one wind generator of a wind generation system, determine wind control instructions based in part on the wind velocity set point, and provide the wind control instructions for the new time interval to the wind generation system, wherein the wind generation system is configured to dynamically generate wind, in accordance with the wind control instructions, in order to simulate changes in at least one of magnitude of the wind and direction of the wind for incidence in a target area in response to movement of the simulated vehicle in a simulation, and the target area is a region that is occupied by a user operating the simulated vehicle.

### BRIEF DESCRIPTION OF THE DRAWINGS

FIG. 1 illustrates an example system architecture of a vehicle simulator, in accordance with one or more embodiments.

FIG. 2A illustrates an example of a vehicle simulator generating wind for providing motion cues for a simulated vehicle at a constant velocity, in accordance with one or more embodiments.

FIG. 2B illustrates an example of generating wind for providing motion cues inclusive of lateral acceleration changes of the simulated vehicle of FIG. 2A.

FIG. 3A illustrates an example embodiment of a portion of a vehicle simulator that includes a plurality of fan assemblies, according to one or more embodiments.

FIG. 3B illustrates an example embodiment of a portion of a vehicle simulator that includes a single fan assembly, according to one or more embodiments.

FIG. 4A illustrates an assembled view of an example embodiment of a fan assembly, according to one or more embodiments.

FIG. 4B illustrates an exploded view of the fan assembly of FIG. 4A.

FIG. 5 is a flowchart for a process for generating motion cues via low latency wind generation, in accordance with some embodiments.

FIG. 6 is a high-level block diagram illustrating an example of a computer for use as a vehicle simulator in accordance with one or more embodiments.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

A vehicle simulator provides a simulation for a user to operate a simulated vehicle (e.g., car, plane, etc.) in a simulation. At least a portion of the user is positioned within a target area. The vehicle simulator generates acceleration cues using a wind generation system that simulates changes in the wind caused by movement (e.g., acceleration) of the simulated vehicle in the simulation. For example, the wind generation system may dynamically generate wind in order to simulate changes in a magnitude of the wind and/or a direction of the wind for incidence in the target area in response to the movement of the simulated vehicle.

The wind generation system uses one or more wind generators to generate the wind to simulate changes in the wind caused by the movement of the simulated vehicle. A wind generator is an air source that is able to generate airflow and rapidly adjust a rate of the airflow being output. For example, a wind generator may be a fan assembly that includes an electric motor in a closed loop control configuration, such as a servo motor or motor with an electronic speed controller (ESC). And in some embodiments, a wind generator may also be able to adjust a direction of the airflow being output (e.g., via electronically actuated louvers).

In some embodiments, the vehicle simulator and/or the wind generation system furthermore includes a simulation controller (which may be implemented in software, firmware, hardware or a combination thereof) to interpret telemetry data from a driving or flight simulation, convert simulated vehicle dynamics (such as acceleration) into velocity settings for the wind generation system, and convert the velocity settings to wind control instructions for controlling one or more wind generators of the wind generator system.

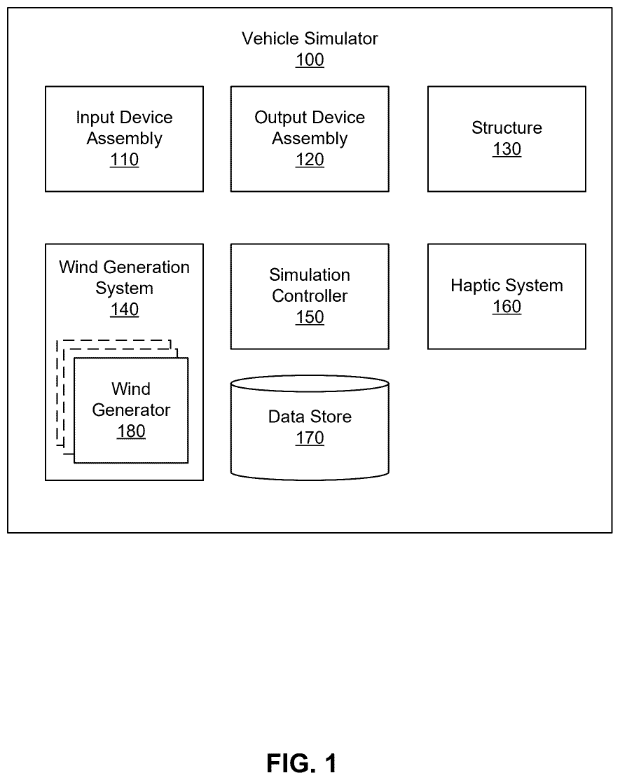

FIG. 1 illustrates an example system architecture of a vehicle simulator 100, in accordance with one or more embodiments. The vehicle simulator 100 provides a simulation for a user. In some embodiments, the simulation may be such that the user operates a simulated vehicle (e.g., car, plane, etc.) in a simulation. In some embodiments, the user may be a passenger of the simulated vehicle. A passenger is a user that is not able to operate (e.g., steer) the simulated vehicle. In some embodiments, the vehicle simulator 100 may provide the simulation to multiple users. There may be, for example: a user operating the simulated vehicle and one or more users that are passengers of the simulated vehicle, multiple users operating the simulated vehicle, multiple passengers of the simulated vehicle, or some combination thereof. The vehicle simulator 100 includes an input device assembly 110, an output device assembly 120, a structure 130, a wind generation system 140, a simulation controller 150, and a data store 170. In some embodiments, the vehicle simulator 100 may also include a haptic system 160. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The input device assembly 110 includes one or more input devices that may be used by a user to interact with the simulation. The one or more input devices may be used to control the simulated vehicle. For example, to control steering, an input device may be, e.g., a steering wheel, joystick, or other input device, and to control velocity and/or acceleration an input device may be e.g., an acceleration pedal, brake pedal, etc. The form of at least some of the one or more input devices may be based on a type of the simulated vehicle. For example, if the simulated vehicle is a Formula 1 race car, at least some of the one or more input devices would emulate the actual controls of a Formula 1 race car (e.g., steering wheel, shift paddles, engine braking, drag reduction system, radio, pit confirm, etc.). Similarly, if the simulated vehicle is an open cockpit bi-plane, at least some of the one or more input devices would emulate the actual controls of the bi-plane (e.g., control yoke, rudder pedals, throttle, etc.). In this manner, the one or more input devices can provide an accurate representation of controls of the real vehicle whose operation is being simulated.

The one or more input devices may furthermore include devices for interacting with various user interfaces of the vehicle simulator 100 to configure parameters, select simulations, start/stop simulations, view information outputs, or perform other functions of the simulator. In some embodiments, the one or more input devices may include a keyboard, a touchscreen, a mouse, a gesture recognition system, a voice recognition system, a microphone, some other means of interacting with the simulation, or some combination thereof.

The output device assembly 120 provides video content to the user using one or more output devices. The video content includes audio content as well as visual content. The one or more output devices includes, e.g., one or more displays, and one or more audio output devices (e.g., speakers). In some embodiments, the one or more displays may include, e.g., conventional display screens and/or head-mounted displays. In some embodiments, an output device may include a helmet configured to provide some or all of the visual content and/or some or all of the audio content to the user.

The structure 130 provides structural support for at least some of the elements of the vehicle simulator 100 using structural elements. Structural elements may include, e.g., a seat for supporting a user, and a frame for supporting some or all one or more other components of the vehicle simulator 100 (e.g., the input device assembly 110, the output device assembly 120, the wind generation system 140, the haptic system 160, etc.). For example, the structure 130 may be configured to replicate a cockpit of the simulated vehicle. For example, the cockpit may be open like that of a Formula 1 race car, an open cockpit aircraft (e.g., biplane), etc. In some embodiments, the structure 130 may provide seats for multiple users. For example, the simulated vehicle may be an open cockpit biplane with two cockpits, one for a pilot of, and one for a passenger. In some embodiments, the structure 130 may have some or all of the one or more displays coupled to it. In other embodiments, the one or more displays are separate from the structure 130 such that the structure 130 may move independent from the one or more displays. In some embodiments, some or all of the structure 130 may be actuated to move in accordance with instructions from the simulation controller 150. In some embodiments, some or all of the structure 130 may be able to adjust its position in multiple degrees of freedom, and in some cases up to six degrees of freedom (e.g., x, y, z, pitch, yaw, and roll).

The wind generation system 140 is configured to dynamically generate wind in accordance with wind control instructions. The generated wind simulates changes in at least one of a magnitude of the wind and a direction of the wind in response to movement of the simulated vehicle in the simulation. The simulated movement may be due to acceleration (e.g., speed change and/or turning) of the simulated vehicle. In some embodiments, the simulated movement may be for a constant velocity of the simulated vehicle, airflow simulating environmental conditions (e.g., simulated explosion), etc. The wind generation system 140 is configured such that the generated wind is directed toward one or more target areas. A target area is a region that is occupied by a user operating the simulated vehicle. In some embodiments, a geometry and/or size of the target area is determined in part by what type of vehicle is being simulated in the simulation. For example, if the actual vehicle being simulated is such that a head of a person in the vehicle would be exposed to wind (e.g., like in a Formula 1 race car) during operation of the actual vehicle, then the target area may be a portion of space occupied by a head of the user. In contrast, if the actual vehicle being simulated is such that most of a person's body would be exposed to wind (e.g., like in paraglider) during operation of the actual vehicle, then the target area would larger to emulate wind conditions experienced during operation of the actual vehicle. In this manner, the wind generation system 140 can better provide motion cues to one or more users in a manner that is representative of what the one or more users would experience during operation of the actual vehicle.

The wind generation system 140 uses one or more wind generators 180 to generate the wind in accordance with the wind control instructions. The one or more wind generators 180 adjust their respective airflow output based on corresponding wind velocity set points in the wind control instructions. For example, the wind generator 180 may receive wind instructions including a wind velocity set point, and the wind generator 180 rapidly adjusts its airflow output in accordance with the received wind velocity set point. In some embodiments, the wind generation system 140 uses a single wind generator 180 to generate wind to simulate motion cues. In other embodiments, the wind generation system 140 may include multiple wind generators 180. For example, the wind generation system 140 may include a left, right, and forward wind generator, where the forward wind generator is positioned in front of the use and used to provide forward motion cues, and the left and right wind generators are positioned to provide left and right motion cues to a user. And in some instances, more than three wind generators may be used to provide motion cues corresponding to additional acceleration axes (e.g., a top wind generator, a bottom wind generator, and/or rear wind generator). Note that as the number of apparent sources (e.g., wind generators) of wind increases, it may provide increased control of available wind directions and/or increased resolution of the direction of wind output by the multiple wind generators 180.

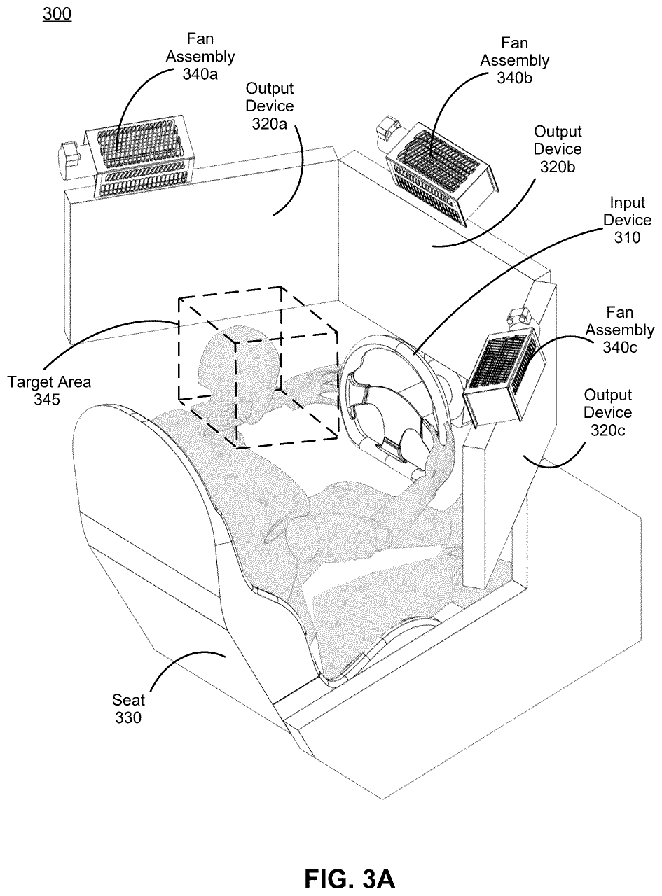

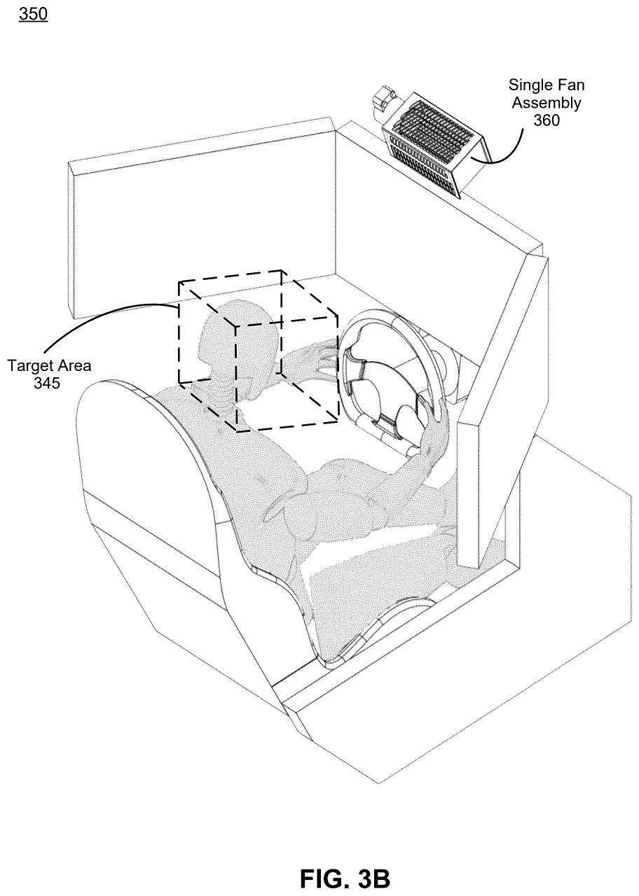

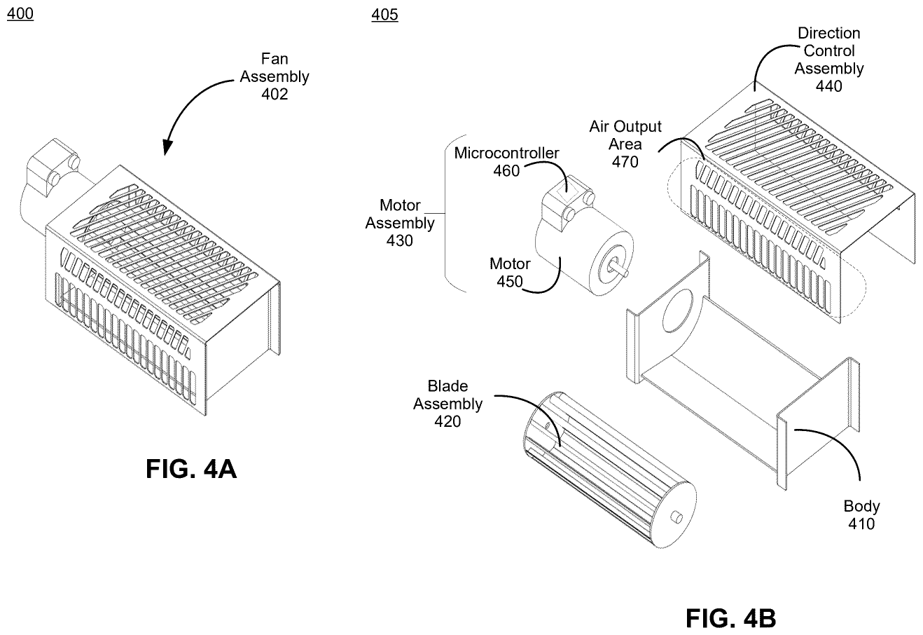

A wind generator 180 is an air source that is able to generate airflow and rapidly adjust a rate of the airflow being output. And in some embodiments, the wind generator 180 may also be able to adjust a direction of the airflow being output. A wind generator may be, e.g., a fan assembly. A fan assembly uses a blade assembly (e.g., plurality of rotating blades), a motor assembly (e.g., rotates the blade assembly), and a direction control assembly (e.g., venting) to generate airflow. The blade assembly and the direction control assembly may be based on designs for, e.g., an enclosed axial fan (axial jet fan, bilge blower, leaf blower, duct fan, etc.), a centrifugal blower (automotive HVAC fan, drying fan), a cross flow blower fan, a cooling and exhaust fan (such as found in computers) modified to include a focusing exhaust duct or enclosure, or other types of fans. In some embodiments, the motor assembly may have a closed loop control configuration (e.g., a motor with ESC, a servo motor) that enables rapid changes in velocity (e.g., rotation per minute) of the blade assembly. A motor assembly with a closed loop control configuration may include a microcontroller, and a motor, where the microcontroller is able to adjust a speed of the motor based on feedback. In some embodiments, the motor assembly uses one or more sensorless motor control algorithms (e.g., back-electromotive force sensing control algorithm, sliding mode observer control algorithm, extended Kalman filter control algorithm, adaptive observer control algorithm, etc.) to generate the feedback, one or more encoders (e.g., magnetic, optical, etc.) to generate the feedback, or some combination thereof. The microcontroller may use the feedback to regulate a drive signal applied to the motor in order to regulate airflow output by the fan assembly. In other embodiments, the motor assembly may have an open loop control configuration (no feedback). The motor assembly enables the fan assembly to respond quickly to changes in input speed commands, unlike a typical fan which would require several seconds to ramp up or down velocity. The direction control assembly directs the airflow to a target area (e.g., region that is at least in part occupied by the user). In some embodiments, the direction control assembly may also be able to dynamically adjust a direction of the airflow it outputs (e.g., via electronically actuated louvers). The fan assembly is further described in detail below with regard to FIGS. 3A, 3B, 4A, and 4B.

In some embodiments, the wind generator 180 uses a single source (e.g., blade assembly) of airflow to generate wind (e.g., concurrently or at different times) from multiple directions. For example, in some embodiments, a fan assembly may include a motor control assembly and blade assembly, and multiple direction control assemblies that are coupled to the blade assembly via ducting. Each of the multiple direction control assemblies is positioned to output airflow from a different direction. In some embodiments, some or all of the ducting and/or some or all of the multiple direction control assemblies may be electronically actuated to control how much airflow is output at each of the multiple direction control assemblies.

In some embodiments, the wind generator 180 may be a compressed air source. A compressed air source includes an air tank, a venting control system, ducting, and one or more direction control assemblies, and may also include an air compressor. The air tank acts as a reservoir for compressed air. The venting control system controls how fast air is vented to the ducting in accordance with instructions from the simulation controller 150. The venting control system may include, e.g., a microcontroller that controls one or more valves that regulate airflow output from the air tank. In some embodiments, the compressed air source may operate in a closed loop control configuration. For example, the compressed air source may also include one or more air flow sensors that can provide feedback (e.g., measured air velocity) to the venting control system. The venting control system may use the feedback to regulate airflow output by the compressed air source. The ducting couples the air tank to the one or more direction control assemblies. In some embodiments, some or all of the ducting and/or some or all of the one or more direction control assemblies may be electronically actuated (e.g., in accordance with instructions from the microcontroller) to control how much airflow is output at each of the one or more direction control assemblies.

Note that each type of wind generator is low latency. A low latency wind generator has a speed adjustment response time of at most 500 milliseconds. The speed adjustment response time is a time a wind generator takes to adjust output of airflow from zero airflow to a maximum airflow. For example, the low latency wind generator may have a response time of 400 milliseconds. A low latency wind generator may also have an initial response time of no more than 100 milliseconds. An initial response time is a time it takes for the wind generator to start changing speed after receipt of a wind velocity set point. And in some embodiments, a low latency wind generator may also operate at a bandwidth of at least 10 Hertz. In contrast, a conventional fan has a speed adjustment response time of several seconds, which is generally too slow to provide motion cues for simulated vehicles.

The simulation controller 150 controls the vehicle simulator 100 in providing a simulation for interacting with a simulated vehicle. The simulation may, e.g., be a simulation of a driving experience, flight experience, or other motion-based experience. The simulation controller 150 uses inputs captured from the one or more input devices and may, in response, dynamically control simulation content output by the vehicle simulator 100. Simulation content may include, e.g., telemetry data of a simulated vehicle, video content (i.e., visual content and audio content) for the simulation, haptic control signals for the haptic system 160 to provide haptic feedback, and wind control instructions for the wind generation system 140. For example, the simulation controller 150 may detects input corresponding to steering changes and/or changes in acceleration, and simulates responses to these inputs using various simulation content (e.g., adjusting a direction and/or magnitude of wind being output to the target area). The simulated responses may provide various motion cues to one or more users participating (e.g., operating the simulated vehicle, acting as passengers, etc.) in the simulation.

In some embodiments, the simulation controller 150 runs all of the simulation locally on the vehicle simulator 100. In some embodiments, some portion of the simulation may be run remote from the vehicle simulator 100. For example, the simulation controller 150 may use one or more application programming interface (APIs) to communicate with a content server coupled to the vehicle simulator via a network. The simulation controller 150 may provide inputs captured from the one or more input devices to the content server. The content server may use the inputs to generate content (e.g., telemetry data, video content) and provide some of the content to the vehicle simulator 100 for presentation. The simulation controller 150 may use the received content to generate the simulation content (e.g., wind control instructions). In some embodiments, the content server may be able to stream simulation content associated with one or more simulations to various vehicle simulators.

The simulation controller 150 may determine telemetry data that describes motion of a simulated vehicle in a simulation. The vehicle simulator may determine telemetry data in accordance with a rate of production (e.g., 20-300 Hertz). For each time new interval, the telemetry data describes at least a vehicle acceleration vector (A_{vehicle}) and a vehicle velocity vector (V_{vehicle}). The telemetry data may also include other data (e.g., position data, simulated altitude, etc.). In some embodiments, the simulation controller 150 calculates the telemetry data based in part on telemetry data from a prior time interval, one or more captured inputs from one or more input devices of the input device assembly 110, one or more environmental conditions (e.g., terrain, wind, effects, etc.) of the simulation, or some combination thereof. In some embodiments, the simulation controller 150 receives the telemetry data from the content server that is running at least a portion of the simulation.

The simulation controller 150 may use the wind generation system 140 to generate wind that functions as a motion cue (e.g., due to sudden acceleration, driving at a constant velocity, etc.) for the one or more users. The simulation controller 150 may determine wind control instructions in accordance with the rate (R) of production of telemetry data for the simulated vehicle. In some embodiments, for each new time interval (1/R) of the rate of production, the simulation controller 150 determines wind control instructions for the new time interval and provides the determined wind control instructions to the wind generation system 140. For example, for a new time interval, the simulation controller 150 may, e.g., determine a wind velocity vector based in part on telemetry data that describes movement of the simulated vehicle for the new time interval. The simulation controller 150 may determine, based in part on the wind velocity vector, a wind velocity set point for each of the one or more wind generators 180. The simulation controller 150 may determine the wind control instructions based in part on the wind velocity set point(s), and provide the wind control instructions for the new time interval to the wind generation system 140.

For example, in an embodiment with a single wind generator 180 that is positioned as a forward wind generator, the simulation controller 150 may determine A_{vehicle} for the simulated vehicle for a new time interval from the telemetry data. In some embodiments, the simulation controller 150 determines A_{vehicle} as a proportion of a maximum acceleration (Aₘₐₓ), where Aₘₐₓ is a scalar that may describe, e.g., a maximum acceleration of the simulated vehicle, an arbitrary upper threshold for simulated vehicle acceleration, a rolling window of recent acceleration values of the simulated vehicle, or some combination thereof. The simulation controller 150 may determine a wind acceleration vector (A_{wind}) for the new time interval by dividing A_{vehicle} by (−Aₘₐₓ). The simulation controller 150 may determine V_{vehicle} for the simulated vehicle for the new time interval from the telemetry data. In some embodiments, the simulation controller 150 determines V_{vehicle} as a proportion of a maximum velocity (Vₘₐₓ), where Vₘₐₓ is a scalar that may describe, e.g., a maximum velocity of the simulated vehicle, an arbitrary upper threshold for velocity of the simulated vehicle, a rolling window of recent velocity values of the simulated vehicle, or some combination thereof. The simulation controller 150 may determine a wind velocity vector (V_{wind}) for the new time interval by dividing V_{vehicle} by (−Vₘₐₓ). The simulation controller 150 may determine the velocity set point of the wind generator 180 based in part on V_{wind}, A_{wind}, or both. For example, the simulation controller 150 may determine a magnitude (V) of V_{wind}, and a magnitude (A) of A_{wind}. The simulation controller may then determine a wind velocity set point (WVSP) for the new time interval:

$$WVSP = Min ( a * V + b * A , {S}_{max} ) \qquad ( 1 )$$

where a and b are weighting factors, Sₘₐₓ is a value representative of an upper limit of wind velocity output by the wind generator 180, and “Min” is a function that selects the lower of “a*V+b*A” and “Sₘₐₓ.” In some embodiments, a may be 0.7, and b may be 0.4. One or more of the values of a and/or b, and Vₘₐₓ and/or Aₘₐₓ (which determine the values of V and A) may be selected such that a value of the WVSP does not exceed Sₘₐₓ. Note that in some embodiments, Sₘₐₓ may be a value that is proportional to an actual value of an upper limit of wind velocity output by the wind generator 180. For example, Sₘₐₓ may be expressed as 1, such that a WVSP is a value from 0 to 1, which can correspond to a range of 0 to 100% of the upper limit of airflow. In other embodiments, Sₘₐₓ may be expressed as the actual upper limit value (e.g., 25 miles per hour). In other embodiments, one or both of a and b may have different values, and in some embodiments they may have a same value. The velocity set point provides a target wind velocity output for the wind generator 180.

Note that additional wind generators may be used to provide directional motion cues (e.g., left, right, up, down, reverse) in addition to a wind generator for forward movement. For example, in an embodiment with left, right, and forward wind generators (such as FIG. 3A), the simulation controller 150 may determine V_{wind} as described above. In some embodiments, the simulation controller 150 may determine what magnitude airflow from each of the left, the right, and the forward wind generators would generate V_{wind} in aggregate. The simulation controller 150 may then determine a wind velocity set point for each of the left, the right, and the forward wind generators using the determined magnitudes.

In some embodiments, the simulation controller 150 may mix directional components to provide lateral motion cues. The simulation controller 150 may determine a wind velocity set point for a wind generator providing lateral motion cues based in part on a magnitude of the wind velocity vector and an amount of lateral acceleration of the simulated vehicle. For example, in a local coordinate system of the simulated vehicle, an x-axis may be perpendicular to a front of the simulated vehicle and be used to describe what is to the left (i.e., −x direction) and right (+x direction) of the simulated vehicle. In this manner, lateral acceleration may be described using a value of an x component of A_{vehicle}. For simplicity, a negative x component of A_{vehicle} may be referred to as “−VehicleLateralAccel,” and a positive x component may be referred to as “+VehicleLateralAccel.” The simulation controller 150 may determine a wind velocity set point for the front wind generator using equation (1). The simulation controller 150 may determine a wind velocity set point for the left wind generator (WVSP_{Left}) as follows:

$$W V S {P}_{Left} = c * V + Min ( Max ( \frac{- VehicleLateralAccel}{- Max LateralAccel} , 0. ) , {S}_{max} ) \qquad ( 2 )$$

where c is a weighting value, and −MaxLateralAccel is an upper limit of lateral acceleration of the simulated vehicle in the −x direction. In some embodiments, c may be 0.3. In other embodiments, c may have some other value. Likewise, the simulation controller 150 may determine a wind velocity set point for the right wind generator (WVSP_{Right}) as follows:

$$W V S {P}_{Right} = d * V + Min ( Max ( \frac{+ VehicleLateralAccel}{+ Max LateralAccel} , 0. ) , {S}_{max} ) \qquad ( 3 )$$

where d is a weighting value, and +MaxLateralAccel is an upper limit of lateral acceleration of the simulated vehicle in the +x direction. In some embodiments, d may be 0.3. In other embodiments, d may have some other value. Note for equations 2 and 3, one or more of the values of c and/or d, and Vₘₐₓ (which affects the values of V) may be selected such that a value of the WVSP_{Right} and WVSP_{Left} does not exceed a maximum output velocity of the wind generator.

In some embodiments, the simulation controller 150 may map different simulated vehicle acceleration values to proportional wind velocity speed set points, where 0=stopped and 100=full velocity airflow. For example, the simulation controller 150 may determine a wind velocity set point expressed as a percentage of Sₘₐₓ for a wind generator via:

$$WVSP = Min ( {F}_{c} / α G * 100 , 100 ) \qquad ( 4 )$$

where F_{c} is the value of an unsigned scalar component of the simulated vehicle acceleration vector, and α is a parameter in the range [0, 1] specifying a proportion of acceleration due to gravity (G) at which the wind generator is at maximum airflow output. For example, for α=0.5, the wind generator is at maximum airflow output if the simulated vehicle acceleration reaches 0.5G.

The simulation controller 150 generates wind control instructions based in part on the determined wind velocity set points for each of the wind generators. In some embodiments, the simulation controller 150 may also determine additional directional control information for one or more of the wind generators. For example, the simulation controller 150 may determine louver positions for electronically actuated louvers of a wind generator based in part on a direction of V_{wind}. And the simulation controller 150 may generate the wind control instructions such that they also include the determined louver positions for the wind generator.

The simulation controller 150 provides the wind control instructions to the wind generation system 140. Responsive to receiving a wind velocity set point, a wind generator rapidly adjusts its output airflow in accordance with the received wind velocity set point. In this manner, the simulation controller 150 is able to extract a vehicle acceleration vector from the telemetry data and map it to forward acceleration cues and lateral left/right acceleration cues that can be provided using the wind generation system 140 to one or more users.

The haptic system 160 may provide haptic feedback to the user via one or more haptic feedback devices. A haptic feedback device may include, e.g., actuators that apply tactile force (e.g., vibration, pressure, etc.) to the one or more users. The one or more haptic feedback devices may be incorporated into various parts of the vehicle simulator 100. For example, the one or more haptic feedback devices may be incorporated into a chair for a user, one or more of the input devices (e.g., the steering wheel), etc. The haptic system 160 provides haptic feedback in accordance with haptic control signals from the simulation controller 150.

The data store 170 stores data for use by the vehicle simulator 100. Data in the data store 70 may include, e.g., one or more simulations, inputs received via the one or more input devices, audio content, visual content, haptic control signals, wind control instructions, and other data relevant for use by the vehicle simulator 100, or any combination thereof. The data store 170 uses computer-readable media to store data, and may use databases to organize the stored data.

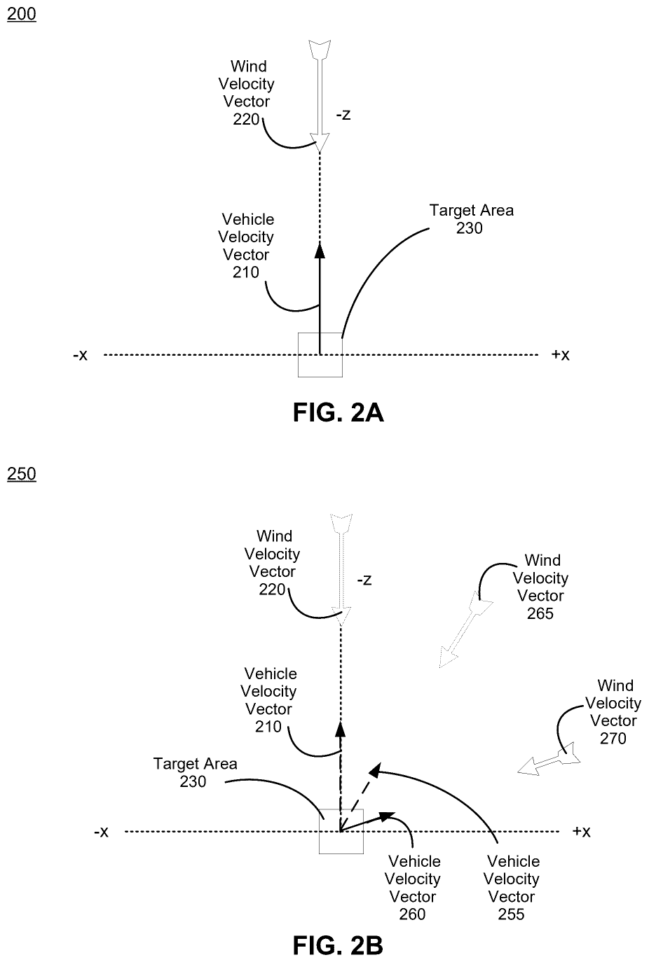

FIG. 2A illustrates an example 200 of a vehicle simulator (e.g., the vehicle simulator 100) generating wind for providing motion cues for a simulated vehicle at a constant velocity, in accordance with one or more embodiments. In the illustrated embodiment, the simulated vehicle has a particular velocity for a time interval, and the velocity is described by a vehicle velocity vector 210. The vehicle velocity vector 210 is a specific example of V_{vehicle}, and may be different for different velocities of the simulated vehicle. In this example, the vehicle velocity vector 210 is oriented along the −z axis. A simulation controller (e.g., the simulation controller 150) uses the vehicle velocity vector 210 to determine a wind velocity vector 220. A direction and/or magnitude of wind to be incident on a target area 230 (e.g., an area occupied by a head of a user of the vehicle simulator 100) may be determined based in part (e.g., via equation 1) on the wind velocity vector 220. The simulation controller instructs a wind generation system (e.g., the wind generation system 140), for the time interval, to generate wind having a magnitude and direction that is based in part on the wind velocity vector 220.

In some embodiments, there may be a single wind generator that is able to adjust both magnitude and direction of the wind it outputs. In FIG. 2A, the vehicle simulator is able to generate wind that provides a cue of travelling to the user in the −z direction at a various speeds and/or accelerations.

In some embodiments there is a plurality of wind generators, and the wind generators are oriented to provide wind from multiple directions toward the target area 230. The simulation controller may selectively control the wind generators to simulate wind from a specific direction at a specific strength.

FIG. 2B illustrates an example 250 of generating wind for providing motion cues inclusive of lateral acceleration changes of the simulated vehicle of FIG. 2A. In the illustrated embodiment, the simulated vehicle initially was moving in accordance with the vehicle velocity vector 210, and then began slowing down as well as turning the simulated vehicle toward +x axis. In this manner, the simulated vehicle moved through a plurality of different vehicle velocity vectors (e.g., vehicle velocity vector 255) for different time intervals before arriving at a vehicle velocity vector 260. For simplicity only a few simulated velocity vectors are illustrated, and they may be separated from each other by multiple time intervals. For example, there may be 100 time intervals between the vehicle velocity vector 210 and the vehicle velocity vector 255.

For a given time interval, the simulation controller may use at least the vehicle velocity vector (and in some embodiments a vehicle acceleration vector) for that time interval to determine a corresponding wind velocity vector, and instructs the wind generation system to generate wind that is based in part on the corresponding wind velocity vector. In this example, the vehicle velocity vector 210, the vehicle velocity vector 255, and the vehicle velocity vector 260 correspond to, respectively, the wind velocity vector 220, a wind velocity vector 265, and a wind velocity vector 270. Note that the wind velocity vector 265 has a different direction and magnitude than that of the wind velocity vector 220. And the wind velocity vector 270 has a different direction and magnitude than that of the wind velocity vector 265. As such, as the simulated vehicle turns in the simulation, the one or more wind generators dynamically adjust a direction and magnitude of the generated wind that is incident on the target area 230. The changes in direction and magnitude of wind incident on the target area 230 provide both directional and speed cues to the user that the simulated vehicle is moving (and is example experiences changes in acceleration).

Note that in the illustrated example, the generated wind is occurring due to motion of the simulated vehicle in the −z and +x directions. By increasing a number of wind generators the vehicle simulator may also provide wind to provide motion cues for motion in one or more other directions (e.g., −x, +y, −y).

FIG. 3A illustrates an example embodiment of a portion 300 of a vehicle simulator that includes a plurality of fan assemblies, according to one or more embodiments. The vehicle simulator is an embodiment of the vehicle simulator 100 for a single user who is operating a simulated vehicle of the simulation. The portion 300 of the vehicle simulator includes an input device 310, an output device 320a, an output device 320b, an output device 320c, a seat 330, a fan assembly 340a, a fan assembly 340b, and a fan assembly 340c. The vehicle simulator also includes a simulation controller which is not shown in FIG. 3A. The output device 320a, the output device 320b, and the output device 320c may collectively be referred to as the output devices 320. Similarly, the fan assembly 340a, the fan assembly 340b, and the fan assembly 340c may collectively be referred to as the fan assemblies 340. In some embodiments, the vehicle simulator may also include other components (e.g., the haptic system 160). Alternative embodiments may include more, fewer, or different components from those illustrated in FIG. 3A, and the functionality of each component may be divided between the components differently from the description below. For example, in some embodiments, the portion 300 may be modified to simulate some other vehicle and/or a simulated vehicle that accommodates multiple users.

The input device 310 may be used by a user to interact with the simulation. The input device 310 is an example input device of the input device assembly 110. In the illustrated embodiment, the input device 310 is a steering wheel for steering a simulated vehicle in the simulation. Note, that while not illustrated in FIG. 3A, the input device 310 and/or the vehicle simulator may include one or more additional input devices (e.g., shift paddles, pedals, microphones, etc.).

The output devices 320 provide visual content to the user. The output devices 320 are example output devices of the output device assembly 120. In the illustrated embodiment the output devices 320 are displays that present visual content of the simulation to the user. Audio content of the simulation may be presented via one or more speakers that are not illustrated. The one more speakers may be, e.g., integrated into one or more of the output devices 320, stand along speakers (not shown), integrated into the seat 330, integrated into a helmet (not shown) of the user, integrated into some other component of the vehicle simulator, or some combination thereof. Note, in some embodiments, some or all of the output devices 320 may be larger and/or at a different distance to the seat 330.

The seat 330 is configured to hold the user. The seat 330 is part of a structure (e.g., the structure 130) of the vehicle simulator. Note that the seat 330 may include one or more haptic devices for providing haptic feedback to the user. Moreover, while not shown, some or all of the portion 300 may be actuated to move in up to six degrees of freedom in response to instructions from the simulation controller.

The fan assemblies 340 are part of a wind generation system (e.g., the wind generation system 140) of the vehicle simulator. The fan assemblies 340 are wind generators that are configured to dynamically generate wind. The generated wind simulates changes in at least one of a magnitude of the wind and a direction of the wind in response to movement of the simulated vehicle. The fan assemblies 340 are oriented to output at least some of the generated wind toward the target area 345. In the illustrated embodiment, the target area 345 is a portion of space that would be occupied by a head of the user. The form factor of the target area 345 may be representative of, e.g., an open cockpit vehicle like a Formula 1 race car, an open cockpit aircraft (e.g., biplane), or some other vehicle where a head of the user would primary be exposed to wind during operation of the vehicle. In FIG. 3A, the fan assembly 340b may be referred to as a forward wind generator (provides forward motion cues), the fan assembly 340a may be referred to as a left wind generator (provides lateral motion cues), and the fan assembly 340c may be referred to as a right wind generator (provides lateral motion cues).

For example, the fan assembly 340a may be configured to output a first airflow in a first direction toward the target area 345. The fan assembly 340a may be configured to adjust a magnitude of airflow output from the fan assembly 340a based in part on a first wind velocity set point of wind control instructions from the simulation controller. Similarly, the fan assembly 340b may be configured to output a first airflow in a second direction toward the target area 345. The fan assembly 340b may be configured to adjust a magnitude of airflow output from the fan assembly 340b based in part on a second wind velocity set point of the wind control instructions. And the fan assembly 340c may be configured to output a third airflow in a third direction toward the target area 345. The fan assembly 340c may be configured to adjust a magnitude of airflow output from the fan assembly 340c based in part on a third wind velocity set point of the wind control instructions. In embodiments, where there are multiple airflows being output (e.g., the first airflow and the second airflow), the multiple airflows combine to form the generated wind used to provide motion cues to the user.

Some or all of the fan assemblies 340 may be in a closed loop control configuration. For example, each of the fan assemblies 340 may have a dedicated motor with ESC or a servo motor that provides rapid adjustment to how much airflow is being output. The direction of the generated wind may be controlled by, e.g., selective control of airflow output from some or all of the fan assemblies 340. For example, the fan assembly 340b may have the largest magnitude of airflow while simulating wind based in part on the wind velocity vector 220 from FIG. 2A. In contrast, the fan assembly 340c may have the largest magnitude of airflow, followed by that of the fan assembly 340b with the fan assembly 340a being inactive while simulating wind based in part on the wind velocity vector 270 from FIG. 2B.

In some embodiments, one or more of the fan assemblies 340 have fixed locations. In other embodiments, one or more of the fan assemblies 340 may move relative to the target area 345 in order affect a direction of the generated wind (i.e., a direction of the wind velocity vector). In some embodiments, one or more of the fan assemblies 340 may have a fixed location but have electronically actuated louvers that can be used to affect a direction of the generated wind. Note that while FIG. 3A includes the fan assembly 340a, the fan assembly 340b, and the fan assembly 340c, in other embodiments there may be some other number of fan assemblies. Moreover, in other embodiments, one or more of the fan assemblies 340 may be located in different positions than shown in FIG. 3A. And in some embodiments, one or more of the fan assemblies 340 may have different form factors than shown in FIG. 3A.

FIG. 3B illustrates an example embodiment of a portion 350 of a vehicle simulator that includes a single fan assembly 360, according to one or more embodiments. The portion 350 of the vehicle simulator is substantially the same as the portion 300 of the vehicle simulator except that the fan assemblies 340 are replaced with a single fan assembly 360.

In FIG. 3B, the single fan assembly 360 is located in front of the user in order to provide motion cues (e.g., acceleration and/or velocity) relating to at least forward motion of the simulated vehicle. The single fan assembly 360 provides the motion cues by controlling one or both of a magnitude of wind and a direction of the wind that is provided to the target area 345.

In some embodiments, the single fan assembly 360 may include electronically actuated louvers that can be used to affect a direction of the generated wind. For example, the simulation controller (e.g., the simulation controller 150) may determine wind control instructions for a new time interval, that control both a magnitude of airflow to be output via a velocity set point and a direction of the airflow to be output via louver positions. And responsive to receipt of the wind control instructions for the new time interval, the single fan assembly 360 may be configured to orient the electronically actuated louvers in accordance with the louver positions and adjust a magnitude of airflow output from the single fan assembly 360 based in part on the velocity set point.

In some embodiments, the single fan assembly 360 has a fixed location. In other embodiments, the single fan assembly 360 may move relative to the target area 345 in order affect a direction of the generated wind. In some embodiments, the single fan assembly 360 may be located in a different position than shown in FIG. 3B. And in some embodiments, the single fan assembly 360 may have a different form factor than shown in FIG. 3B.

FIG. 4A illustrates an assembled view 400 of an example embodiment of a fan assembly 402, according to one or more embodiments. The fan assembly 402 is an embodiment of the wind generator 180, and may correspond to one of the fan assemblies 340 and/or the single fan assembly 360. The fan assembly 402 may have a design suitable for directing focused airflow at medium-to-high speeds. For example, an operational velocity range of wind generated by the fan assembly 402 may be 0 to 25 miles per hour. The fan assembly 402 is configured to be able to rapidly make adjustments in magnitude of airflow output from the fan assembly 402. The fan assembly 402 may include a (partial or full) enclosure designed to direct and focus airflow.

FIG. 4B illustrates an exploded view 405 of the fan assembly 402 of FIG. 4A. The fan assembly 402 includes a body 410, a blade assembly 420, a motor assembly 430, and a direction control assembly 440. In some embodiments, the fan assembly 402 may also include other components. Alternative embodiments may include more, fewer, or different components from those illustrated in FIG. 4B, and the functionality of each component may be divided between the components differently from the description below.

The body 410 is a structure that provides support for the components of the fan assembly 402. The body 410 is configured to couple to the blade assembly 420, the motor assembly 430, and the direction control assembly 440. The body 410 may shaped in part to help direct airflow generated by rotation of the blade assembly 420.

The blade assembly 420 includes a plurality of blades arranged to rotate about an axis of rotation to generate airflow. The plurality of blades may be curved to direct the airflow tangentially from the axis of rotation as the blade assembly 420 rotates about the axis of rotation.

The motor assembly 430 is configured to rotate the blade assembly 420 in accordance with a wind velocity set point (e.g., received from the simulation controller 150). The motor assembly 430 includes a motor 450 and a microcontroller 460 that may be in a closed loop control configuration or an open loop control configuration. In some embodiments, the motor 450 and microcontroller 460 may be a servo motor, or a motor with ESC. The motor 450 is configured to provide rapid acceleration and deceleration rates, and operate over a range of rotational velocities. The motor 450 and the microcontroller 460 have a speed adjustment response time of at most 500 milliseconds. The motor assembly 430 may also have an initial response time of no more than 100 milliseconds and operate at a bandwidth of at least 10 Hertz. The motor assembly 430 enables the fan assembly 402 to respond quickly (i.e., low latency) to changes in wind velocity set points, unlike a typical fan which may take at least several seconds to ramp up or down a velocity of airflow.

The microcontroller 460 translates a wind velocity set point (e.g., received in wind control instructions) to a corresponding drive signal for the motor 450. The drive signal may specify, e.g., a pulse width modulation (PWM) duty cycle of a PWM signal that is applied to the motor 450 in order for the fan assembly 402 to output airflow in accordance with the wind velocity set point. The microcontroller 460 may use a model that maps different wind velocity set points to corresponding drive signals for the motor 450 to determine what rotational speed to drive the motor 450 at for a given time interval. For example, the model may map a wind velocity set point of 20 miles per hour to a first drive signal of the motor 450, and may map a wind velocity set point of 25 miles per hour to a second drive signal of the motor 450.

In some embodiments, the motor assembly 430 is in a closed loop control configuration. In the closed loop control configuration, the motor assembly 430 controls rotational speed and/or position of the motor 450 using feedback. The feedback may be determined via one or more sensorless motor control algorithms and/or using one or more encoders (not shown). The microcontroller 460 may use the feedback to accurately control a rotational speed (and in some embodiments position) of the motor 450. For example, the motor assembly 430 may include an encoder that is configured generate feedback in response to monitoring an actual rotational speed of the motor 450. The microcontroller 460 may be configured to use the feedback to adjust a drive signal applied to the motor 450 such that an actual rotational speed (determined from the feedback) is within a threshold value of a target rotational speed associated with the wind velocity set point. The threshold value may be, e.g., +/−1% of the target rotational speed associated with the wind velocity set point. The encoder may be magnetic, optical, some other rotational encoder type, or some combination thereof.

Calibration of the model may be generated via a process where different drive signals are applied to the motor 450, and wind speed of the generated wind is measured. The measured speed corresponds to a wind velocity set point. The measured wind speeds may be mapped to the corresponding drive signals to form a set of mapped data. The model may be calibrated using the mapped data, such that the model may output, for a given wind velocity setpoint, a corresponding drive signal for the motor 450.

In some embodiments, the motor assembly 430 is configured to rotate the blade assembly 420 in accordance with the last received velocity set point received. Such that from one time interval to the next, the motor assembly 430 continues to rotate the blade assembly 420 in accordance with the velocity set point until the motor assembly 430 is instructed otherwise (which may be multiple time intervals later).

The direction control assembly 440 outputs wind generated by rotation of the blade assembly 420 in a direction towards a target area of the vehicle simulator. The direction control assembly 440 at least partially encloses the blade assembly 420. The direction control assembly 440 includes an intake area and an air output area 470. The air output area 470 is positioned to direct the generated wind toward the target area. In FIG. 4B the air output area 470 is on one of three sides of the direction control assembly 440, and the air intake area is on other two sides of the direction control assembly 440. In some embodiments, the direction control assembly 440 may also include an optional guard to prevent foreign objects from entering the fan assembly 402.

The air output area 470 includes a plurality of louvers that direct the airflow toward the target area. In some embodiments, some or all of the plurality of louvers are fixed such that a direction of airflow output from the fan assembly 402 is fixed. In other embodiments, some or all of the plurality of louvers are electronically actuated louvers that can adjust a direction of airflow output from the fan assembly 402. In these embodiments, the electronically actuated louvers may be oriented in accordance with louver positions received from the simulation controller 150.

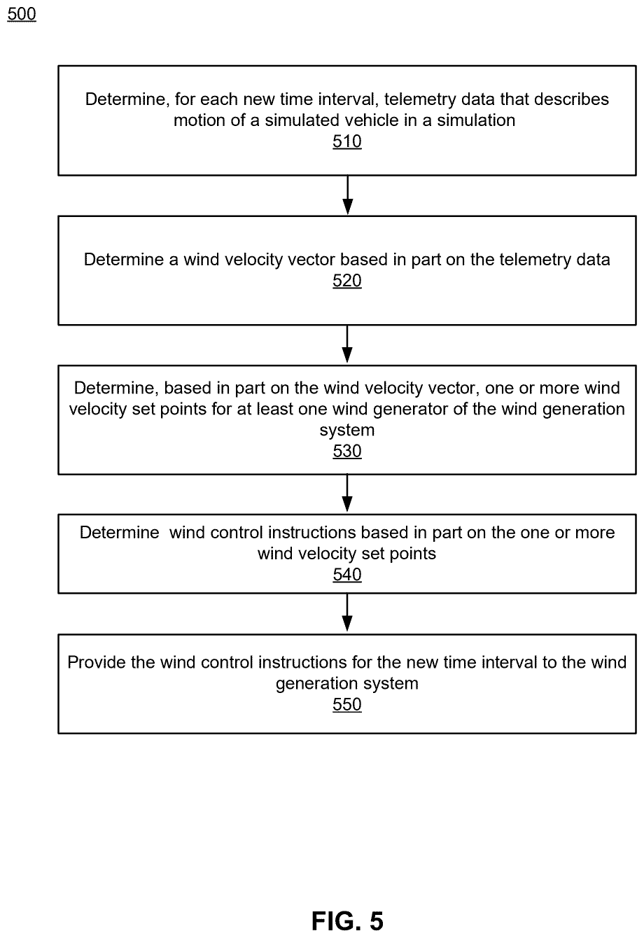

FIG. 5 is a flowchart for a process for generating motion cues via low latency wind generation, in accordance with some embodiments. Alternative embodiments may include more, fewer, or different steps from those illustrated in FIG. 5, and the steps may be performed in a different order from that illustrated in FIG. 5. These steps may be performed by a vehicle simulator (e.g., the vehicle simulator 100). Additionally, each of these steps may be performed automatically by the vehicle simulator without human intervention.

The vehicle simulator determines 510, for each new time interval, telemetry data that describes motion of a simulated vehicle in a simulation. In some embodiments, the vehicle simulator calculates the telemetry data based in part on telemetry data from a prior time interval, one or more captured inputs from one or more input devices of an input device assembly (e.g., the input device assembly 110), one or more environmental conditions of the simulation, or some combination thereof. In some embodiments, the vehicle simulator obtains the telemetry data from a content server that is running at least a portion of the simulation. The vehicle simulator may determine telemetry data in accordance with a rate of production (e.g., 20-300 Hertz). For each time new interval, the telemetry data describes at least a vehicle acceleration vector (A_{vehicle}) and a vehicle velocity vector (V_{vehicle}). The telemetry data may also include other data (e.g., position data, simulated altitude, etc.).

The vehicle simulator determines 520 a wind velocity vector (V_{wind}) based in part on the telemetry data. In some embodiments, the vehicle simulator may determine a maximum velocity (Vₘₐₓ). The vehicle simulator may determine Vₘₐₓ (e.g., a maximum velocity of the simulated vehicle, an arbitrary upper threshold for velocity of the simulated vehicle, a rolling window of recent velocity values of the simulated vehicle, or some combination thereof). The vehicle simulator may determine V_{wind} for the new time interval by dividing V_{vehicle} by (−Vₘₐₓ).

The vehicle simulator determines 530, based in part on the wind velocity vector, one or more wind velocity set points for at least one wind generator of the wind generation system. In some embodiments, the vehicle simulator may identify which combination of one or more wind generators and what magnitude of airflow should be produced in order to generate wind simulating the wind velocity vector.

In some embodiments, the vehicle simulator may also determine the wind based in part on acceleration of the simulated vehicle. For example, the vehicle simulator may determine Aₘₐₓ (e.g., a maximum acceleration of the simulated vehicle, an arbitrary upper threshold for simulated vehicle acceleration, a rolling window of recent acceleration values of the simulated vehicle, or some combination thereof). The vehicle simulator may determine a wind acceleration vector (A_{wind}) for the new time interval by dividing A_{vehicle} by (−Aₘₐₓ). For example, the simulation controller 150 may determine a magnitude (V) of V_{wind}, a magnitude (A) of A_{wind}, a value for lateral acceleration (e.g., −VehicleLateralAccel, +VehicleLateralAccel), or some combination thereof. The vehicle simulator may determine the one or more wind velocity set points using equation (1), equation (2), equation (3), equation (4), or some combination thereof.

The vehicle simulator determines 540 wind control instructions based in part on the one or more wind velocity set points. The vehicle simulator generates the wind control instructions based at least on the one or more wind velocity set point. Each wind velocity set point may be for a different wind generator. Additionally, in some embodiments, the vehicle simulator may further determine louver positions for electronically actuated louvers of a wind generator in order to further direct the generated wind based in part on a direction of the wind velocity vector. In these embodiments, the vehicle simulator generates the wind control instructions based on the one or more wind velocity set points as well as the determined louver positions.

The vehicle simulator provides 550 the wind control instructions for the new time interval to the wind generation system. In some embodiments, the wind control instructions are only provided to wind generators whose output is being adjusted for the new time interval. The wind control instructions may be provided, e.g., a serial port, some other communication link, or some combination thereof.

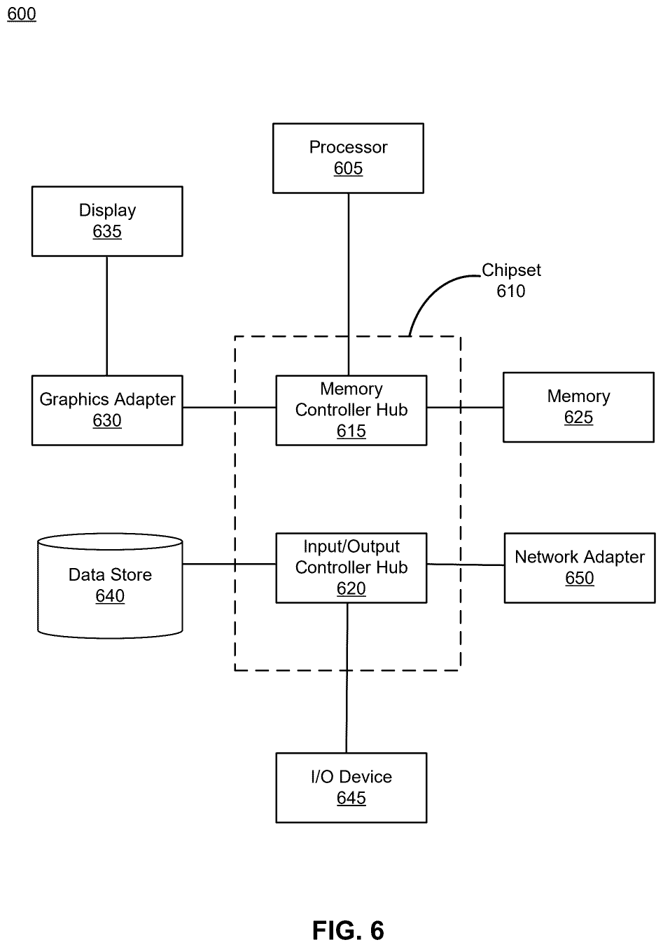

FIG. 6 is a high-level block diagram illustrating an example of a computer 600 for use as a vehicle simulator 100 in accordance with one or more embodiments. In some embodiments, some or all of the computer 600 may be representative of an example content server. Illustrated are at least one processor 605 coupled to a chipset 610. The chipset 610 includes a memory controller hub 615 and an input/output (I/O) controller hub 620. A memory 625 and a graphics adapter 630 are coupled to the memory controller hub 615, and a display 635 is coupled to the graphics adapter 630. A data store 640, one or more I/O devices 645, and network adapter 650 are coupled to the I/O controller hub 620. Other embodiments of the computer 600 have different architectures. For example, the memory 625 is directly coupled to the processor 605 in some embodiments.

The data store 640 includes one or more non-transitory computer-readable storage media such as a hard drive, solid-state memory device, or other storage medium. The data store 170 may be implemented as the data store 640. The memory 625 holds instructions and data used by the processor 605. The one or more I/O devices 645 may be used to input data into the computer 600. The graphics adapter 630 displays images and other information on the display 635. In some embodiments, the display 635 includes a touch screen capability for receiving user input and selections. The network adapter 650 couples the computer 600 to a network.

The vehicle simulator 100 and/or the content server may comprise one or more enterprise computing or storage systems, cloud computing or storage systems, or a combination thereof and may be implemented utilizing local or cloud-based servers. The servers may include physical servers, virtual machines, or a combination thereof. Cloud-based servers may include private cloud systems, public cloud systems, hybrid public/private cloud systems, or a combination thereof. Furthermore, different portions of the vehicle simulator 100 and/or the content server may execute on different remote servers and various system elements of the vehicle simulator 100 and/or the content server may be communicatively coupled over the network. Some functions of the vehicle simulator 100 and/or the content server may utilize services accessible via an API associated with respective services.

The computer 600 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the data store 640, loaded into the memory 625, and executed by the processor 605.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A vehicle simulator comprising:
a structure including a cockpit configured to be occupied by a user for operation of a simulated vehicle of a simulation;
an input device that is coupled to the structure and that is configured to receive inputs from the user to steer the simulated vehicle within the simulation;
an output device configured to provide video content for the simulation;
a wind generation system configured to dynamically generate wind using one or more wind generators that operate in a closed loop control configuration, in accordance with wind control instructions, in order to simulate changes in at least one of a magnitude of the wind and a direction of the wind for incidence in a target area in response to movement of the simulated vehicle, wherein the target area is occupied by the user; and
a simulation controller that is configured to:
generate, based in part on inputs received from the input device, the wind control instructions for at least one wind generator of the one or more wind generators, and
provide the wind control instructions to the wind generation system.

2. The vehicle simulator of claim 1, wherein the simulation controller is further configured to:
for each new time interval of the simulation,
determine a wind velocity vector based in part on telemetry data that describes the movement of the simulated vehicle for the new time interval,
determine, based in part on the wind velocity vector, a wind velocity set point for the at least one wind generator,
determine the wind control instructions based in part on the wind velocity set point, and
provide the wind control instructions for the new time interval to the wind generator.

3. The vehicle simulator of claim 2, wherein the simulation controller is further configured to:
for each new time interval of the simulation,
determine a vehicle acceleration vector and a vehicle velocity vector for the simulated vehicle for the new time interval from the telemetry data, and
determine the wind velocity vector based in part on the vehicle acceleration vector and the vehicle velocity vector.

4. The vehicle simulator of claim 1, wherein the wind generation system further comprises:
a first fan assembly that is a wind generator of the one or more wind generators and is oriented to output a first airflow in a first direction toward the target area, and the first fan assembly is configured to adjust a magnitude of airflow output from the first fan assembly based in part on a first wind velocity set point of the wind control instructions; and
a second fan assembly that is a wind generator of the one or more wind generators and is oriented to output a second airflow in a second direction toward the target area, and the second fan assembly is configured to adjust a magnitude of airflow output from the second fan assembly based in part on a second wind velocity set point of the wind control instructions,
wherein the generated wind is formed in part from the first airflow and the second airflow.

5. The vehicle simulator of claim 1, wherein the wind generation system comprises:
a single fan assembly that is a wind generator of the one or more wind generators and is oriented to output the wind toward the target area, and the single fan assembly is configured to adjust a magnitude of airflow output from the single fan assembly based in part on a wind velocity set point of the wind control instructions.

6. The vehicle simulator of claim 5, wherein the single fan assembly includes electronically actuated louvers that can adjust a direction of airflow output from the single fan assembly, and the simulation controller is further configured to:
for each new time interval of the simulation,
determine a wind velocity vector based in part on telemetry data that describes the movement of the simulated vehicle for the new time interval,
determine, based in part on the wind velocity vector, the wind velocity set point and louver positions for the single fan assembly, and
determine the wind control instructions based in part on the wind velocity set point and the louver positions,
wherein responsive to receipt of the wind control instructions for the new time interval, the single fan assembly is configured to orient the electronically actuated louvers in accordance with the louver positions and adjust a magnitude of airflow output from the single fan assembly based in part on the wind velocity set point, and the generated wind for the new time interval is formed from the airflow.

7. The vehicle simulator of claim 1, wherein the at least one wind generator is a fan assembly that comprises:
a blade assembly configured to rotate to produce airflow;
a direction control assembly that at least partially encloses the blade assembly and includes a plurality of louvers that direct the airflow;
a microcontroller that uses a model to map wind velocity set points to corresponding drive signals; and
a motor that rotates the blade assembly in accordance with a drive signal received from the microcontroller.

8. The vehicle simulator of claim 7, wherein the motor and the microcontroller have a speed adjustment response time of at most 500 milliseconds.

9. The vehicle simulator of claim 1, wherein the one or more wind generators is a plurality of wind generators that is configured to:
dynamically generate the wind, in accordance with the wind control instructions, in order to simulate changes in both the magnitude of the wind and the direction of the wind for incidence in the target area.

10. A system comprising:
a wind generation system configured to dynamically generate wind, in accordance with wind control instructions, in order to simulate changes in at least one of magnitude of the wind and direction of the wind for incidence in a target area in response to movement of a simulated vehicle in a simulation, wherein the target area is a region that is occupied by a user operating the simulated vehicle; and
a simulation controller that is configured to:
for each new time interval of the simulation,
determine a wind velocity vector based in part on telemetry data that describes the movement of the simulated vehicle for the new time interval,
determine, based in part on the wind velocity vector, a wind velocity set point for at least one wind generator of the wind generation system,
determine the wind control instructions based in part on the wind velocity set point, and
provide the wind control instructions for the new time interval to the wind generation system.

11. The system of claim 10, wherein the simulation controller is further configured to:
for each new time interval of the simulation,
determine a vehicle acceleration vector and a vehicle velocity vector for the simulated vehicle for the new time interval from the telemetry data, and
determine the wind velocity vector based in part on the vehicle acceleration vector and the vehicle velocity vector.

12. The system of claim 10, wherein the wind generation system comprises:
a first fan assembly that is a first wind generator and is oriented to output a first airflow in a first direction toward the target area, and the first fan assembly is configured to adjust a magnitude of airflow output from the first fan assembly based in part on a first wind velocity set point of the wind control instructions; and
a second fan assembly that is a second wind generator and is oriented to output a second airflow in a second direction toward the target area, and the second fan assembly is configured to adjust a magnitude of airflow output from the second fan assembly based in part on a second wind velocity set point of the wind control instructions,
wherein the generated wind is formed in part from the first airflow and the second airflow.

13. The system of claim 10, wherein the at least one wind generator comprises:
a single fan assembly oriented to output the wind toward the target area, and the single fan assembly is configured to adjust a magnitude of airflow output from the single fan assembly based in part on the wind velocity set point.

14. The system of claim 13, wherein the single fan assembly includes electronically actuated louvers that can adjust a direction of airflow output from the single fan assembly, and the simulation controller is further configured to:
for each new time interval of the simulation,
determine, based in part on the wind velocity vector, the wind velocity set point and louver positions for the single fan assembly, and
determine the wind control instructions based in part on the wind velocity set point and the louver positions,
wherein responsive to receipt of the wind control instructions for the new time interval, the single fan assembly is configured to orient the electronically actuated louvers in accordance with the louver positions and adjust a magnitude of airflow output from the single fan assembly based in part on the wind velocity set point, and the generated wind for the new time interval is formed from the airflow.

15. The system of claim 10, wherein the at least one wind generator is a fan assembly that comprises:
a blade assembly configured to rotate to produce airflow;
a direction control assembly that at least partially encloses the blade assembly and includes a plurality of louvers that direct the airflow;
a microcontroller that uses a model to map wind velocity set points to corresponding drive signals; and
a motor that rotates the blade assembly in accordance with a drive signal received from the microcontroller.

16. The system of claim 15, wherein the motor and the microcontroller have a speed adjustment response time of at most 500 milliseconds.

17. The system of claim 15, wherein the fan assembly further comprises:
an encoder configured generate feedback in response to monitoring an actual rotational speed of the motor,
wherein the microcontroller is configured to use the feedback to adjust a drive signal applied to the motor such that the actual rotational speed is within a threshold value of a target rotational speed associated with the wind velocity set point.

18. The system of claim 10, wherein the at least one wind generator is a forward wind generator that is configured to generate wind from in front of the target area in order to simulate motion cues for forward motion of the simulated vehicle, and the wind generation system further comprises:
a second wind generator positioned to generate wind incident in the target area to simulate motion cues for lateral motion of the simulated vehicle.

19. The system of claim 18, wherein the simulation controller is further configured to:
determine a wind velocity set point for the second wind generator based in part on a magnitude of the wind velocity vector and an amount of lateral acceleration of the simulated vehicle.

20. A non-transitory computer-readable storage medium comprising stored instructions, the instructions when executed by a processor of a device, cause the device to:
for each new time interval of a simulation for operating a simulated vehicle,
determine a wind velocity vector based in part on telemetry data that describes movement of the simulated vehicle for the new time interval,
determine, based in part on the wind velocity vector, a wind velocity set point for at least one wind generator of a wind generation system,
determine wind control instructions based in part on the wind velocity set point, and
provide the wind control instructions for the new time interval to the wind generation system,
wherein the wind generation system is configured to dynamically generate wind, in accordance with the wind control instructions, in order to simulate changes in at least one of magnitude of the wind and direction of the wind for incidence in a target area in response to movement of the simulated vehicle in a simulation, and the target area is a region that is occupied by a user operating the simulated vehicle.
